(19) United States
(12) Patent Application Publication
(10) Pub. No.: US 2005/0060241 A1
(43) Pub. Date: Mar. 17, 2005

(54) Vehicle information voicemail system and method thereof

(76) Inventor: Charles Williams, Snellville, GA (US)

Correspondence Address: MYERS & KAPLAN, INTELLECTUAL PROPERTY LAW, L.L.C., 1899 POWERS FERRY ROAD, SUITE 310, ATLANTA, GA, 30339, US

(21) Appl. No.: 10/939,399

(22) Filed: Sep. 13, 2004

Related U.S. Application Data
(60) Provisional application No. 60/502,696, filed on Sep. 12, 2003.

(51) Int. Cl. G06F 17/60

(52) U.S. Cl. 705/27

(57) ABSTRACT

A vehicle information voicemail system and method thereof that provides a vehicle seller of any type with an economical means of providing detailed data regarding vehicle particulars and a means of acquiring contact information from interested buyers without the seller and buyer having to speak directly, without limiting the hours during which such information is accessible, without requiring the need for specialized mechanical and/or electronic equipment, and without exposing personal data regarding the potential seller.

### CROSS-REFERENCE TO RELATED APPLICATIONS

To the full extent permitted by law, the present application claims priority to and the benefit as a non-provisional application to provisional patent application entitled “Vehicle Information Voicemail System and Method Thereof” filed on Sep. 12, 2003, having assigned Ser. No. 60/502,696.

### COPYRIGHT NOTICE

A portion of the disclosure of this patent document contains material which is subject to copyright protection. The copyright owner has no objection to the facsimile reproduction by anyone of the patent document or patent disclosure as it appears in the U.S. Patent and Trademark Office patent file or records, but otherwise reserves all copyright rights whatsoever.

### TECHNICAL FIELD

The present invention relates generally to vehicle advertising services and associated methods, and more specifically to a vehicle voicemail information system and method thereof. The present invention is particularly suitable for, although not strictly limited to, enabling individual and/or corporate vehicle sellers to benefit from a personalized voice mail advertisement and corresponding voice mail box, wherein a potential buyer can receive detailed information regarding a vehicle to be sold and can leave contact information for the seller.

### BACKGROUND OF THE INVENTION

Upon deciding to purchase a new vehicle, many individuals choose to sell their previous vehicle for cash instead of trading. Presently available methods of advertising are limited for such individual sellers and typically include placement of a classified advertisement in a newspaper or auto book, and/or placement of a sign in the vehicle window. Each of these methods enables the seller to convey a minimal amount of information about the vehicle and to provide the seller's telephone number for contact for more detailed information.

The use of a vehicle sign disadvantageously limits the amount of information that can be provided to the potential buyer without speaking with the seller. Moreover, many individuals, especially women, have privacy concerns regarding the display of their telephone number in such a public and nonspecific manner. This same privacy concern carries over into classified advertisements, wherein the inclusion of the seller's telephone number often can result in undesirable telephone contact. Moreover, the ease and availability of reverse number look-up services, wherein the address of record for a given telephone number can be acquired, enables substantially anyone to locate a seller's home and potentially invade their personal privacy.

Vehicle sales from a dealer or used-car facility proceed in much the same manner, albeit substantially without the privacy issues. Potentially costly print and television advertisements are frequently utilized to convey limited information regarding available vehicles. Potential buyers can then call or visit the dealership for additional information, but must usually speak with a salesperson in order to receive further data. Alternatively, a potential buyer may browse car lots and may read pricing information printed on a window display for a vehicle of interest. Again, because such display information is usually limited, in order to receive additional information, the buyer must typically speak with a salesperson.

Car salespeople, especially within the used car market, are often presumed to practice particularly annoying tactics and/or to be unpleasant. As a result, even if such a stereotype is unwarranted, many prospective buyers prefer to avoid any such contact unless or until absolutely necessary. Therefore, such prospective buyers often browse car lots after hours. Unfortunately, if a vehicle is of particular interest, the car lot loses the moment of peak opportunity because there is no one present to provide additional information to the potential buyer.

In order to overcome this disadvantage, at least one device for audio-playback of information has been designed, wherein the device is removably mounted on a for-sale vehicle and selectively plays information regarding said vehicle. Although the device does enable a potential buyer to receive additional data, even after hours, the expense of purchasing and maintaining the number of units necessary to place one unit on each vehicle could easily be prohibitively disadvantageous.

Therefore, it is readily apparent that there is a need for a vehicle information voicemail system and method thereof that provides a vehicle seller of any type with an economical means of providing detailed data regarding vehicle particulars and a means of acquiring contact information from interested buyers without the seller and buyer having to speak directly, without limiting the hours during which such information is accessible, without requiring the need for specialized mechanical and/or electronic equipment, and without exposing personal data regarding the potential seller.

### BRIEF SUMMARY OF THE INVENTION

Briefly described, in a preferred embodiment, the present invention overcomes the above-mentioned disadvantages and meets the recognized need for such a system and method by providing a vehicle voicemail information system and method wherein individual and/or corporate vehicle sellers receive a personalized voicemail advertisement and corresponding voice mail box and wherein a potential buyer can receive detailed information regarding the vehicle to be sold and can leave contact information for the seller.

According to its major aspects and broadly stated, the present invention in its preferred form is a vehicle information voicemail system and method thereof that provides a vehicle seller of any type with an economical means of providing detailed data regarding vehicle particulars and a means of acquiring contact information from interested buyers without the seller and buyer having to speak directly, without limiting the hours during which such information is accessible, without requiring the need for specialized mechanical and/or electronic equipment, and without exposing personal data regarding the potential seller.

More specifically, the present invention in its preferred form is a vehicle advertising and sales system and method, wherein dedicated and personalized voice mailbox services offer potential buyers substantially unlimited access to vehicle data. The system and method is beneficial to individual sellers, as well as to new car dealers, used-car lots, and/or any other type of vehicle sales-based entity.

Preferably, a voice mailbox is maintained by the provider of the system, wherein a network of such voice mailboxes, each related to a particular vehicle, are maintained. An individual vehicle seller can contract with the service provider to receive a personalized voice box number and/or a dealer/used car lot can contract with the service provider to receive a plurality of personalized voice box numbers. A call to a selected voice box number enables the caller to listen to a talking advertisement, that is, pre-recorded information regarding the features and terms of purchase for the selected vehicle to be sold. If interested, the caller can leave a message for the seller, wherein the seller can follow-up as desired.

In the preferred embodiment, window signs are provided for individual buyers upon subscription to the system, wherein general vehicle information is displayed, as well as the voice mailbox access number. Dealer and/or used car lot subscribers may opt for message recording, updating and other management activities of the voice mail box system to be performed by the system provider. However, on-site recording and updating of messages may optionally be selected. Additionally, subscribers to the vehicle information voice mail system may elect to offer a pager, email, telephone and/or cellular selection option for potential buyers who call the voice mail box, wherein the seller could elect to enable essentially immediate contact with the potential buyer. The vehicle information voice mail system may be offered in concert with published classified advertisements such as, for exemplary purposes only, newspapers, magazines, or on-line services.

For example, the newspapers can sign up people at the time the classified ad is placed. The salesperson informs the seller that they can add a voicebox to their classified ad for an additional fee for each thirty-day (30) lease. Each voicebox will come with up to three (3) minutes to record the options of that persons vehicle (new tires, exhaust, tune-up, point, custom wheels, stereo, car kit) anything to attract a buyer quicker. All voiceboxes will be pass code protected to maintain security of received messages. The consumer would receive an EX-CAR-GO For-Sale sign. Each sign will be artistically designed to attract attention to the vehicle. The voicebox number of the client will be displayed on the sign. Each sign will have multiple options available for checking off. This allows people the chance to read the options available at a glance. Potential buyers call the EX-CAR-GO Voice-Ad, enter the seller's voicebox number and listen to the vehicle's features. When a buyer leaves his contact information for the seller, the voice-network will forward a message waiting signal to the seller (pager, email, cell phone) so they can return the call immediately.

Accordingly, a feature and advantage of the present invention is its ability to enable a potential buyer to receive detailed information regarding a vehicle to be sold irrespective of the time of day of inquiry.

Another feature and advantage of the present invention is its ability to enable a seller to convey detailed information to any potential buyer without necessitating direct contact therewith.

Another feature and advantage of the present invention is its ability to protect the privacy of a vehicle seller and/or a potential buyer.

Another feature and advantage of the present invention is its ability to capture a potential buyer during their initial peak interest period.

A further feature and advantage of the present invention is its ability to convey detailed information regarding a particular vehicle on a car lot without necessitating direct contact with a salesperson.

Another feature and advantage of the present invention is its ability to seize upon the interest of after-hours car lot browsers.

An additional feature and advantage of the present invention is its ability to provide on-site access to immediate vehicle information without requiring the use of a dedicated electronic device.

Still another feature and advantage of the present invention is its ability to provide a vehicle seller of any type with an economical means of providing detailed data regarding vehicle particulars.

Another feature and advantage of the present invention is its ability to provide a means of acquiring contact information from interested buyers without the seller and buyer having to speak directly.

Another feature and advantage of the present invention is its ability to provide a means of acquiring contact information from interested buyers without limiting the hours during which such information is accessible.

Yet another feature and advantage of the present invention is its ability to provide a means of acquiring contact information from interested buyers without requiring the need for specialized mechanical and/or electronic equipment.

Still yet another feature and advantage of the present invention is its ability to provide a means of acquiring contact information from interested buyers without exposing personal data regarding the potential seller.

Another feature and advantage of the present system is its ability to enable essentially immediate contact with the potential buyer, at the seller's discretion.

These and other features and advantages of the present invention will become more apparent to one skilled in the art from the following description and claims when read in light of the accompanying drawings.

### BRIEF DESCRIPTION OF THE DRAWINGS

The present invention will be better understood by reading the Detailed Description of the Preferred and Selected Alternate Embodiments with reference to the accompanying drawing figures, in which like reference numerals denote similar structure and refer to like elements throughout, and in which:

FIG. 1 is a general flow diagram of the method for a vehicle information voice mail system according to the preferred embodiment of the present invention, showing an individual seller example;

FIG. 2 is a general flow diagram of the method for a vehicle information voice mail system according to the preferred embodiment of the present invention, showing a car lot/dealer example;

FIG. 3 is a vehicle detail information sheet for the vehicle information voice mail system and method as shown in FIGS. 1 and 2, according to the preferred embodiment of the present invention; and

FIG. 4 is a vehicle sign for the vehicle information voice mail system and method as shown in FIG. 1, according to the preferred embodiment of the present invention.

### DETAILED DESCRIPTION OF THE PREFERRED AND SELECTED ALTERNATIVE EMBODIMENTS

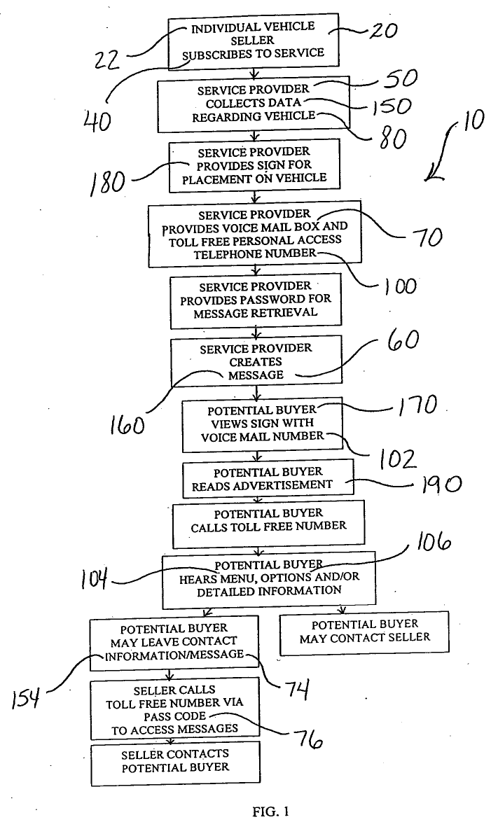

In describing the preferred and alternate embodiments of the present invention, as illustrated in FIGS. 1-4, specific terminology is employed for the sake of clarity. The invention, however, is not intended to be limited to the specific terminology so selected, and it is to be understood that each specific element includes all technical equivalents that operate in a similar manner to accomplish similar functions.

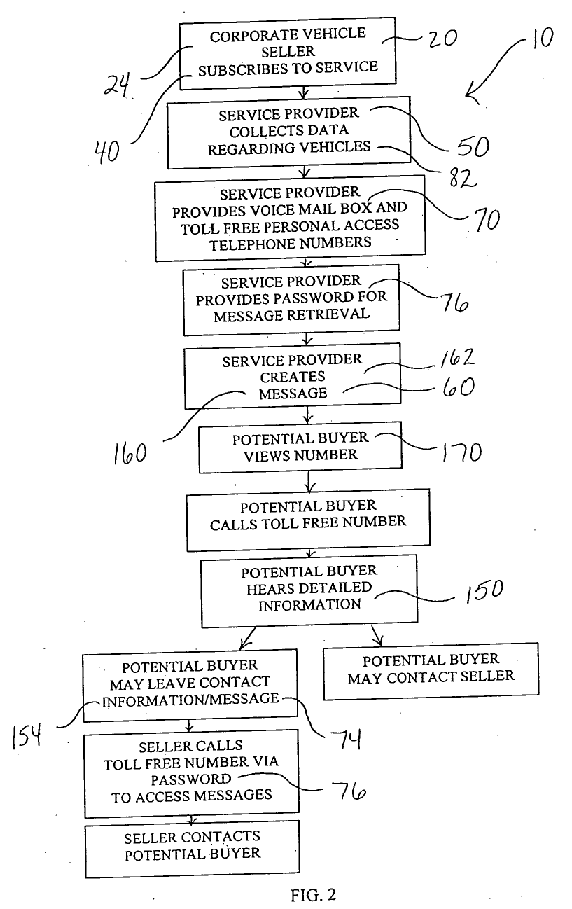

Referring now to FIGS. 1 and 2, the present invention in a preferred embodiment is a vehicle information voicemail system 10 and method thereof, wherein vehicle sellers 20, such as individual 22 and/or corporate 24 sellers preferably enter into a contract 40 with service provider 50 (preferably marketed under the trademark EX-CAR-GO) to receive preferably personalized voicemail advertisement 60 and corresponding voice mail box 70 for a particular vehicle 80.

Preferably, service provider 50 acquires a toll-free telephone access number 100 and a plurality of voice mail boxes 70 and sub-mail boxes 72 (not shown). Service provider 50 preferably initiates and maintains the plurality of voice mail boxes 70 and sub-mail boxes 72, preferably leasing the same from known telecommunications provider 130 (not shown). Each voice mail box 70 is preferably sub-leased to vehicle seller 20 for selected duration 140 (not shown).

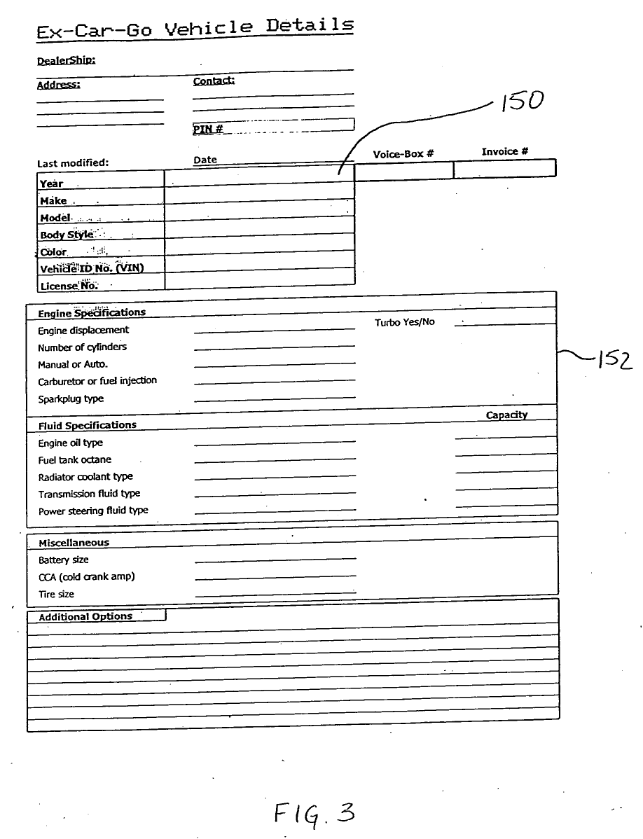

In the preferred embodiment, wherein vehicle seller 20 is individual seller 22, as depicted in FIG. 1, with particular vehicle 80 to sell, specific and detailed information 150 regarding vehicle 80 is preferably collected from individual seller 22 via data form 152, as depicted in FIG. 3. It is contemplated that information 150 other than that depicted in FIG. 3 could be collected, wherein any style or appropriate means of data collection could be utilized. Information 150 is preferably collected by service provider 50, wherein personalized message 160 is preferably created by service provider 50 for playback to potential buyer/caller 170 via voice mail box 70. Although it is preferred that service provider 50 create personalized message 160, one skilled in the art would readily recognize that, in an alternate embodiment, personalized message 160 could be created by individual seller 22.

Preferably, voice mail box 70, and personalized message 160 thereof, is associated with vehicle 80 via toll-free telephone access number 100 and mail box code 102, wherein potential buyer/caller 170 can preferably access information 150 via toll-free telephone access number 100. Preferably, incoming buyer/callers 170 receive standardized menu 104 offering options 106, wherein options 106 preferably include entry of mail box code 102 to hear information 150. In the preferred embodiment, incoming buyer/caller 170 has knowledge of mail box code 102 for vehicle 80 of interest. It is contemplated, however, that in an alternate embodiment, options 106 could also include sub-menu option 108 (not shown), wherein incoming buyer/caller 170 could review categorized listing of vehicles 80, such as for exemplary purposes only, by color, make, model, year, geographic location, or any other appropriate means of categorization, and wherein incoming buyer/caller 170 could thereby effectively search for information 150 regarding vehicle 80 of interest without having knowledge of mail box code 102, for example, if mail box code 102 was misplaced or forgotten.

Preferably, voice mail box 70 conveys information 150 to buyer/caller 170 and is capable of receiving contact information 154 therefrom. That is, preferably, potential buyer/caller 170 can leave voice message 74 in voice mail box 70, wherein individual seller 22 can preferably retrieve voice message 74 at any time by utilizing pass code 76 selective for voice messages 74 held within voice mail box 70.

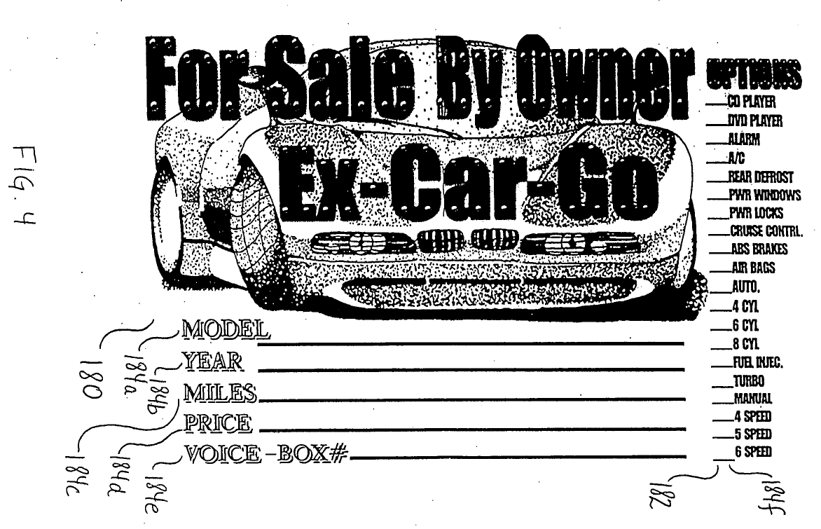

Preferably, service provider 50 provides individual seller 22 with vehicle sign 180, as depicted in FIG. 4, wherein individual seller 22 preferably completes selections 182 and places vehicle sign 180 into a display position on vehicle 80. In the preferred form, vehicle sign 180 selections 182 include model 184a, year 184b, mileage 184c, price 184d, voice box number 184e, and selectable options 184f, thereby enabling standardized information to be displayed to any potential buyers. Although vehicle sign 180 is preferably designed with information as depicted in FIG. 4, any information could be provided thereon, including additional information, or only voice mail box 70.

In the preferred embodiment, as depicted in FIG. 2, wherein vehicle seller 20 is corporate seller 24, such as, for exemplary purposes only, new car dealer, used-car lot, and/or any other type of vehicle sales-based entity, with a plurality 82 of particular vehicles 80 to sell, specific and detailed information 150 regarding each vehicle 80 of plurality of vehicles 82 is preferably collected from corporate seller 24 via data form 152, as depicted in FIG. 3. It is contemplated that information 150 other than that depicted in FIG. 3 could be collected, wherein any style or appropriate means of data collection could be utilized.

Information 150 is preferably collected by service provider 50, wherein a plurality 162 of personalized messages 160 are preferably created by service provider 50 for individualized playback for each vehicle 80 to potential buyer/caller 170 via voice mail box 70, wherein each vehicle 80 of plurality of vehicles 82 would preferably have a specific voice mail box 70 with preferably specific personalized message 162 therein. Although it is preferred that service provider 50 create personalized message 160, one skilled in the art would readily recognize that, in an alternate embodiment, personalized message 160 could be created by corporate seller 24.

Preferably, as with an individual seller 22, voice mail box 70, and personalized message 160 thereof, is associated with vehicle 80, preferably via toll-free telephone access number 100 and mail box code 102, wherein potential buyer/caller 170 can preferably access information 150 via toll-free telephone access number 100. Preferably, incoming buyer/callers 170 receive standardized menu 104 offering options 106, wherein options 106 preferably include entry of mail box code 102 to hear information 150. In the preferred embodiment, incoming buyer/caller 170 has knowledge of mail box code 102 for vehicle 80 of interest. It is contemplated, however, that in an alternate embodiment, options 106 could also include sub-menu option 108, wherein incoming buyer/caller 170 could review a categorized listing of vehicles 80, such as for exemplary purposes only, by color, make, model, year, geographic location, or any other appropriate means of categorization, and wherein incoming buyer/caller. 170 could thereby effectively search for information 150 regarding vehicle 80 of interest without having knowledge of mail box code 102, for example, if mail box code 102 was misplaced or forgotten. Alternately, sub-menu option 108 could include only information regarding vehicles 82 offered for sale by corporate seller 24, or could include pre-recorded advertisement for corporate seller 24.

Preferably, voice mail box 70 plays information 150 to buyer/caller 170 and is capable of receiving contact information 154 therefrom. That is, preferably potential buyer/caller 170 can leave voice message 74 in voice mail box 70, wherein corporate seller 24 can preferably retrieve voice message 74 at any time by utilizing pass code 76 selective for voice messages 74 held within each voice mail box 70 of plurality of voice mail boxes 72.

Preferably, corporate seller 24 receives plurality of personalized voice box numbers 72, wherein a call to a selected voice box number 70 for particular vehicle 80 preferably enables potential buyer/caller 170 to listen to a talking advertisement, that is, pre-recorded information regarding the features and terms of purchase for selected vehicle 80 to be sold. If interested, potential buyer/caller can leave a message for corporate seller 24 including contact information 154, wherein corporate seller 24 can follow-up as desired.

In the preferred embodiment, service provider 50 provides message recording services, updating of data and messages and other management activities. It is contemplated, however, in an alternate embodiment that access code 78 (not shown), in lieu of or in addition to, pass code 76, could enable access to plurality of voice mail boxes 70 for on-site recording and updating of messages by corporate seller 24.

Preferably, as depicted in FIG. 1, vehicle information voicemail system 10 includes cooperative classified advertisement 190 via publisher 200 (not shown), such as, for exemplary purposes only, newspapers, magazines, or on-line services. Preferably, service provider 50 compensates publisher 200 for offering participation in vehicle information voicemail system 10 to purchasers of classified advertisements 190, wherein voice mail box 70 is preferably provided as a point of contact in the printed or electronic advertisement. Publisher 200 preferably receives payment from service provider 50 based upon the number of cooperative classified advertisements 190 that are sold, wherein publisher 200 preferably realizes a new income stream substantially without any expenditure or outlay. Moreover, publisher 200 could increase income by realizing an increase in classified advertisement sales upon consumer awareness of cooperative classified advertisements 190.

In an alternate embodiment, service provider 50 could verify the veracity of specific and detailed information 152 from data form 150, wherein potential buyer/caller 170 would have increased incentive to seek vehicles for sale via vehicle information voicemail system 10.

In an alternate embodiment, initial call in to toll-free access number 100 could playback an advertisement for cooperative goods and/or services such as, for exemplary purposes only, auto parts, vehicle service/inspection check, tires, etc., wherein such an advertisement could be played before standardized menu 104 selection options are provided and could be heard by each potential buyer/caller 170. The cooperative goods and/or services provider could compensate voice mail service provider 50 for such a recorded advertisement, whereby such advertisement would be economically beneficial for each party.

In an another alternate embodiment, vehicle seller 20 could use access code 78 to manage voice message 74 associated therewith, wherein vehicle seller 20 could record initial message 74, update the information in voice message 74, and/or could selectively notify system provider 50 of changes to the account, such as the sale of vehicle 80 or the desire to renew voice mail box 70.

In another alternate embodiment, vehicle seller 20 could use access code 78 and sub-menu options 108 to notify system provider 50 of changes to the account, such as the sale of vehicle 80 or the desire to renew voice mail box 70.

In another alternate embodiment, vehicle sign 180 could be completed via connection to a global networking system, such as the Internet, wherein vehicle sign 180 could be delivered to vehicle seller 20 and/or vehicle seller 20 could download and print vehicle sign 180 on-site.

In another alternate embodiment, service provider 50 could manage a website, wherein vehicle seller 20 could select to participate in vehicle information voice mail system 10 thereon, wherein photographs of vehicle 80 could be posted, and wherein email messages of inquiry could be sent to vehicle seller 20 therethrough.

In another alternate embodiment, access to sub-menu options 108 could enable potential buyer/caller 170 to send a text message, email message or pager message to vehicle seller 20.

In yet another alternate embodiment, service provider 50 could offer vehicle seller 20 an option to elect and/or lease a pager, email address, and/or cellular telephone, and/or to enable a selection option for potential buyer/caller 170 within voice mail box 70, whereby vehicle seller 20 could elect to enable essentially immediate contact with any potential buyer/caller 170.

In another alternate embodiment, service provider 50 could offer personalized message 160 to include a novelty message such as, for exemplary purposes only, an impersonation or licensed character voice.

In an alternate embodiment, access code 78, in lieu of or in addition to, pass code 76, could enable access to plurality of voice mail boxes 70 for on-site recording and updating of messages by corporate seller 24.

In another alternate embodiment, sub-menu option 108 could include only information regarding vehicles 82 offered for sale by corporate seller 24, or could include pre-recorded advertisement for corporate seller 24.

In another alternate embodiment, corporate seller 24 could lease a plurality of voice mail boxes 70, wherein personalized message 160 could be created by corporate seller 24 and managed directly thereby.

In another alternate embodiment, service provider 50 could offer voice mail system 10 wherein vehicle seller 20, either individual or corporate, initiates and maintains own voice mail box 70.

In another alternate embodiment, service provider 50 could offer placement/viewing of vehicle 80 at a physical location or vehicle display lot.

Having thus described exemplary embodiments of the present invention, it should be noted by those skilled in the art that the within disclosures are exemplary only, and that various other alternatives, adaptations, and modifications may be made within the scope of the present invention. Merely listing the steps of the method in a certain order does not constitute any limitation on the order of the steps of the method. Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation. Accordingly, the present invention is not limited to the specific embodiments illustrated herein, but is limited only by the following claims.

1. A system and method for providing vehicle information, comprising the steps of:
a) leasing at least one voice mail box to a vehicle seller, wherein said at least one voice mail box is accessible via a toll-free number and code;
b) acquiring data from the vehicle seller regarding a vehicle for sale;
c) creating an outgoing message for said at least one voice mail box, said outgoing message including said data regarding the vehicle;
d) enabling a potential buyer/caller to selectively record an incoming message for the vehicle seller; and enabling the vehicle seller to access said incoming message.
